(19) United States
(12) Patent Application Publication
(10) Pub. No.: US 2026/0131263 A2
(43) Pub. Date: May 14, 2026

(54) FILTRATION SYSTEM

(71) Applicant: The Pennington School, Pennington, NJ (US)

(72) Inventors: Susan WIRSIG, Pennington, NJ (US); Avery SICHEL, Pennington, NJ (US); Maxwell GIBBARD, Pennington, NJ (US); Daisy HUTNIK, Pennington, NJ (US); Elliot OVERHISER, Pennington, NJ (US); Gloria LIU, Pennington, NJ (US); John L. FERMO, Pennington, NJ (US); Ronan KARP, Pennington, NJ (US); Christopher LY, Pennington, NJ (US); Shubh GANGRADE, Pennington, NJ (US); Xiaona ZHU, Pennington, NJ (US); Liam GOLDSTEIN, Pennington, NJ (US); Miami CELENTANA, Pennington, NJ (US); Samuel BAHALA, Piedmont, CA (US); Lefted KANYIKA, Lilongwe (MW)

(73) Assignee: The Pennington School, Pennington, NJ (US)

(21) Appl. No.: 19/229,410

(22) Filed: Jun. 5, 2025

Related U.S. Application Data
(60) Provisional application No. 63/657,244, filed on Jun. 7, 2024.

(51) Int. Cl. B01D 24/10; B01D 24/00; B01D 24/40; B01D 24/42; B01D 39/04; B01D 39/06; C02F 1/00; C02F 1/50; C02F 103/00

(52) U.S. Cl. CPC B01D 24/105; B01D 24/002; B01D 24/007; B01D 24/402; B01D 24/425; B01D 39/04; B01D 39/06; C02F 1/002; C02F 1/50; B01D 2101/04; B01D 2201/4092; C02F 2103/002; C02F 2201/004; C02F 2303/04; C02F 2307/02

(57) ABSTRACT

The present disclosure provides a device, a system, and a method for filtering liquids, in particular for filtering gray water such that it can be reused for multiple purposes. Also provided is an optional step of purifying the liquid with a chemical such that the filtered liquid is also potable.

### CROSS-REFERENCE TO RELATED APPLICATION

This application claims the benefit of U.S. Provisional Application No. 63/657,244, filed Jun. 7, 2024, which is hereby incorporated by reference in its entirety into the present application.

### BACKGROUND

Liquids can become contaminated for a number of reasons. Standing liquids that are not kept at cool temperatures or that are allowed to stand for long periods, can become contaminated with bacteria, making them non-potable, or even less desirable for routine use.

In many areas of the world, people do not have access to sufficient clean water supplies for drinking, or even for washing dishes or clothing. The World Health Organization (WHO) recommends that each individual should have access to twenty liters of water every day. In many areas of the world, particularly in areas where there is no running water, people only have access to half or less than half of the WHO recommended amount of water per day and must travel to water sources that may be contaminated, or to boreholes where they might obtain limited amounts of potable water. The water obtained must be carried back to homes and businesses to be used for multiple purposes. As such, the ability to filter greywater (gray water) for reuse for those multiple purposes, and also optionally to purify the water to make it potable, would decrease the amount of time and effort associated with accessing a water supply, and thus would increase the daily amount of water available to people in those areas toward the level recommended by the WHO.

In addition, there may also be limited resources in such areas with which to effectively filter liquids/water for use or reuse. Thus, development of a device and/or system for filtering liquids, such as contaminated water, whose components are readily assembled, utilizing locally sourced, readily available and low-cost materials for filtration, is also desired.

### SUMMARY

The following brief summary is not intended to include all features and aspects of the present disclosure, nor does it imply that the disclosure must include all features and aspects discussed in this summary.

The present disclosure provides a device that can be combined with readily available, locally sourced materials, to create a system for filtering liquids, in particular water.

In one aspect, the device is a basin or “sink” into which the liquid can be introduced. The basin comprises one or more shafts extending from the bottom of the basin, which shaft, or shafts provide a conduit for the liquid to flow by gravity from the basin into one or more receptacles containing materials designed to provide filtration and removal of contaminants from the liquid.

The shaft or shafts of the basin may contain internal threading such that the one or more receptacles can be screwed into the basin.

The disclosure further provides a system for filtering liquids that comprises the basin and the one or more receptacles, and optionally a vessel for collecting the filtered liquid.

Another aspect of the disclosure is a method of filtering liquids that utilizes the filtration system.

Yet a further aspect of the disclosure is a method of purifying liquids utilizing the filtration system in combination with a purifying chemical.

One further aspect of the disclosure is a kit comprising the basin, instructions for assembling the filtration system, and optionally one or more further components of the filtration system.

The foregoing and other objects, features and advantages of the disclosure will be apparent from the following more particular description of embodiments of the disclosure, as illustrated in the accompanying drawings in which like reference characters refer to the same parts throughout the different views. The drawings are not necessarily to scale, emphasis instead being placed upon illustrating the principles of the disclosure.

### BRIEF DESCRIPTION OF THE DRAWINGS

FIG. 1 shows a top view of the claimed Filtration Device.

FIG. 2 shows a bottom view the claimed Filtration Device.

FIG. 3 shows a side view of the Filtration Device.

FIG. 4 shows an oblique view of the Filtration Device.

FIG. 5 shows the basin or “sink” of the Filtration Device and how it combines via threading in the shaft(s) with one or more receptacles containing filtration materials.

FIG. 6 shows an expanded view of the connection between the basin and the receptacle.

FIG. 7 shows the Filtration System that includes a vessel for receiving filtered liquid and an optional syphon for removing filtered liquid from the vessel and delivering it to a collection container.

### DETAILED DESCRIPTION

Unless defined otherwise, all technical and scientific terms used herein have the same meaning as commonly understood by those of ordinary skill in the art to which this disclosure belongs. Although any methods and materials similar or equivalent to those described herein can be used in the practice or testing of the present disclosure, the preferred methods and materials are described. Generally, nomenclatures are those well-known and commonly used in the art. Certain experimental techniques, not specifically defined, are generally performed according to conventional methods well known in the art.

The disclosure provides a device and a system for filtering liquids, as well as methods for filtering and optionally also purifying the liquid, such as water, to make it potable. The device and system incorporate components that are readily available and assembled, locally sourced, and low cost because the system uses locally available resources such as rocks, sand and cotton. The layered filtration approach in some aspects can remove bacteria, metals and other debris. In some embodiments, components may be recyclable waste, the reuse of which has an additional positive impact on the environment. The device is particularly well suited for individual/in-home use in low-resource communities that lack reliable access to clean water and can be reused. In some aspects, the device can be connected to a water pump to allow for higher volume and relatively continuous flow.

In yet more detail, the present disclosure is described by the following items which represent preferred embodiments thereof.
1. A filtration device comprising a basin for receiving liquid to be filtered, wherein said basin comprises one or more shafts on the bottom surface of the basin, and wherein the one or more shafts are configured to tightly connect to a receptacle for receiving and filtering the liquid.
2. The filtration device of item 1 comprising multiple shafts.
3. The filtration device of item 1 comprising four shafts.
4. The filtration device of item 1 composed of plastic.
5. A filtration system comprising the filtration device of item 1, into which one or more receptacles are threaded into the shafts.
6. The filtration system of item 5, wherein the one or more receptacles comprise one or more layers of filter materials.
7. The filtration system of item 6, wherein the one or more receptacles comprise a layer of fibrous material.
8. The filtration system of item 7, wherein the one or more receptacles further comprise a granular layer on top of the layer of fibrous material.
9. The filtration system of item 8, wherein the one or more receptacles further comprise a layer of a mineral material on top of the granular layer.
10. The filtration system of item 7, wherein the fibrous material is cotton.
11. The filtration system of item 8, wherein the granular material is sand.
12. The filtration system of item 8, wherein the mineral material is rocks or gravel.
13. The filtration system of item 6, wherein the one or more receptacles comprise holes at a bottom edge of the receptacle.
14. The filtration system of item 13, further comprising a vessel into which the basin and threaded receptacles are placed, such that the liquid can flow from the basin, be filtered through the receptacles, and be received as filtered liquid in the vessel.
15. The filtration system of item 14, further comprising tubing which acts as a syphon to remove filtered liquid from the vessel.
16. The filtration system of item 15, further comprising a collection container for receiving the filtered liquid via the tubing from the vessel.
17. The filtration system of any preceding item, wherein the liquid is water.
18. A method for filtering liquid, comprising introducing the liquid into the filtration system of any one of items 5-17 and collecting filtered liquid.
19. The method of item 18, wherein the basin comprises multiple shafts.
20. The method of item 18, wherein the basin comprises four shafts.
21. The method of item 18, wherein the basin is composed of plastic.
22. A method of item 18, wherein one or more receptacles are threaded into the shafts of the basin.
23. The method of item 22, wherein the one or more receptacles comprise one or more layers of filter materials.
24. The method of item 23, wherein the one or more receptacles comprise a layer of fibrous material.
25. The method of item 24, wherein the one or more receptacles further comprise a granular layer on top of the layer of fibrous material.
26. The method of item 25, wherein the one or more receptacles further comprise a layer of a coarse mineral material on top of the granular layer.
27. The method of item 24, wherein the fibrous material is cotton.
28. The method of item 25, wherein the granular material is sand.
29. The method of item 26, wherein the coarse mineral material is rocks or gravel.
30. The method of item 22, wherein the one or more receptacles comprise holes at a bottom edge of the receptacle.
31. The method of item 23, wherein the filtration system further comprises a vessel into which the basin and one or more threaded receptacles are placed, such that the liquid can flow from the basin, be filtered through the one or more receptacles, and be received as filtered liquid in the vessel.
32. The method of item 31, wherein the filtration system further comprises tubing which acts as a syphon to remove filtered liquid from the vessel.
33. The method of item 18, wherein the filtration system further comprises a collection container for receiving the filtered liquid via the tubing from the vessel.
34. The method of any one of items 19-33, wherein the liquid is water.
35. The method of item 34, further comprising prior to introducing the liquid into the basin, treating the liquid for at least 10 minutes with a purification chemical.
36. The method of item 35, wherein the purification chemical is chlorine or a molecule containing chlorine.
37. The method of item 36, wherein the purification chemical is calcium hypochlorite.
38. A kit for filtering liquids, comprising:
a. a basin for receiving liquid to be filtered, wherein said basin comprises one or more shafts for transmitting fluid to one or more receptacles; and
b. instructions for assembling a filtering system.
39. The kit of item 38, further comprising one or more receptacles to receive filtering materials.
40. The kit of item 39, further comprising filtering components to be introduced into said one or more receptacles, wherein said filtering components comprise:
   a. a fibrous material;
   b. a granular material; and
   c. a coarse mineral material.
41. The kit of any one of items 38-40, further comprising a chemical purifying agent.
42. The kit of item 41, wherein the chemical purifying agent is calcium hypochlorite.

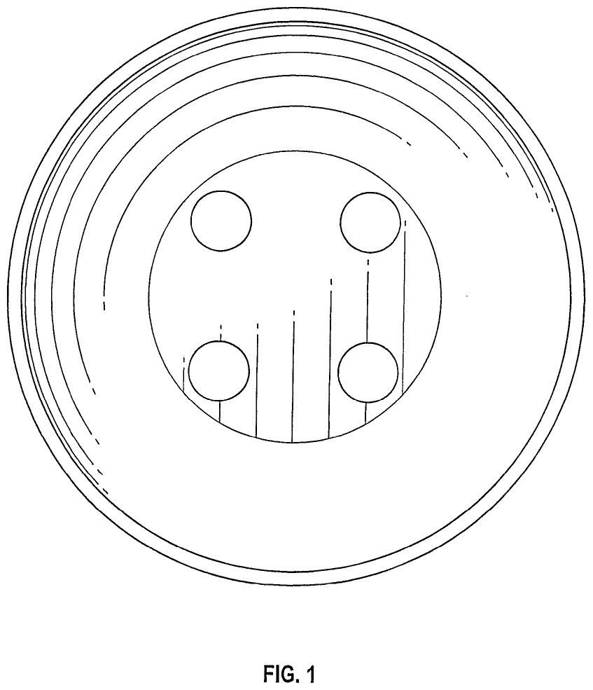

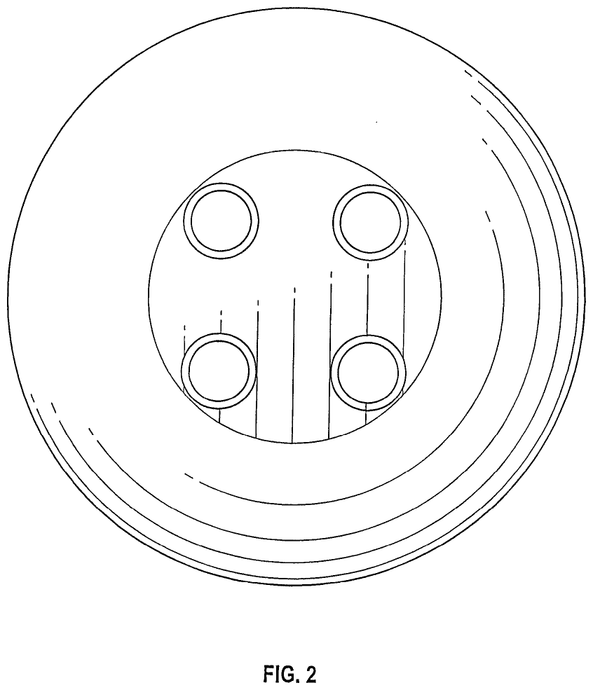

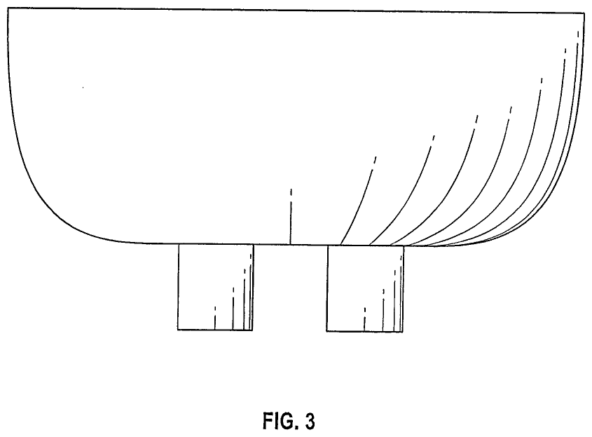

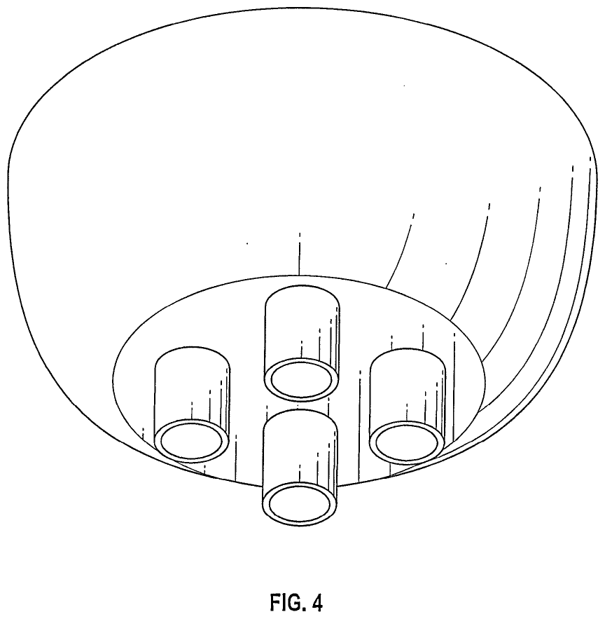

The filtration device can be composed of various materials, including polypropylene, and other “plastics.” The filtration device is preferably molded such that the basin and shaft portions are a single piece that is not subject to leakage between the basin and the shafts (e.g., FIGS. 1-4). The basin may hold about 1 to about 10, and preferably up to 4 liters of liquid at one time, but as the water is filtered, additional liquid can be added, preferably about 2 to about 8 liters, more preferably about 3, about 4, about 5 or about 6 liters. The filtration device comprises one or more shafts through which liquid flows from the basin to the receptacles that filter the liquid. Preferably, the filtration device comprises multiple shafts, preferably 2, 3, 4, 5 6, 7 or 8 shafts, most preferably 4 shafts.

The shafts of the filtration device are designed to connect with one or more receptacles into which the liquid flows from the basin and through the shaft. The shaft or shafts are designed with a connection which prevents substantial leakage between the shaft and the receptacle. In one embodiment, the connection comprises threads into which the receptacle is screwed. In other embodiments, the connection may be rubber gasket or tubing that allows the receptacle to fit tightly into the shaft.

The filtration device fitted with internal threading is particularly well suited to engage a receptacle that also has a threaded top portion. In one embodiment, the receptacle is a plastic water bottle, preferably capable of holding at least about a pint to about a quart of liquid, or about 16 to about 32 ounces of liquid, about 400 to about 1000 ml, preferably about 500 ml or about 600 ml. In one embodiment, the receptacle is a 500 ml “Cool Drop” water bottle.

The one or more receptacles include one or more layers of filter materials. Preferably, the one or more receptacles include a layer of fibrous material, which may be cotton, preferably in the form of cotton balls, linen, a granular layer on top of the layer of fibrous material, which may be sand, and a layer of coarse mineral material on top of the granular layer, which may be rocks or gravel. The one or more receptacles should each include one or more holes at the bottom edge of the receptable through which filtered liquid will flow. The number of holes will depend on the volume and size of the receptacle, but preferably there will be at least two, at least 3, at least 4, at least 5 or at least 6 holes in the bottom of the receptacle. Together, the basin and one or more receptacles comprise a filtration system.

The filtration system may further include a vessel into which the basin and threaded receptacles are placed, such that the liquid can flow from the basin, be filtered through the receptacles, and be received as filtered liquid in the vessel. The size of the vessel depends on the amount of liquid to be filtered, the size of the basin and the number of receptacles attached thereto. In one embodiment, the vessel is a plastic pitcher, preferably able to collect at least one, at least two, at least three or at least four gallons of filtered liquid. The vessel may optionally be fitted with tubing which acts as a syphon to remove filtered liquid from the vessel, in which case the syphon will deposit the filtered liquid into a collection container.

The filtration system is particularly well suited for filtering gray water for reuse. In one embodiment, filtered gray water is treated with a purifying chemical, preferably calcium hypochlorite, such that the filtered and purified water is potable. Chemicals suitable for removing bacteria and/or other contaminants from liquids such as water are well known to those of skill in the art, and the choice may be in accordance with existing local health guidelines.

Also included in the present disclosure are methods of filtering, and optionally purifying a liquid, utilizing the filtration device and system.

Also included in the present disclosure are kits comprising the filtration device and/or system, as well as instructions for using the same.

The following examples are provided to aid the understanding of the present disclosure, the true scope of which is set forth in the appended claims. It is understood that modifications can be made in the procedures set forth without departing from the spirit of the disclosure.

### EXAMPLES

### Example 1

Six to eight cotton balls were placed in the bottom of four 500 ml empty “Cool Drop” water bottles (receptacles), using a wooden dowel to ensure the bottom of the bottle was fully covered and the cotton balls packed in tightly. 5-7 cm of sand was added on top of the cotton ball layer, and 5-7 cm of small rocks were placed on top of the layer of sand. Four holes were punched into the bottom of each of the four water bottles with an awl.

Each of the four water bottles was flushed by running approximately one liter of water through each bottle. This step reduced turbidity and allowed the sand and rocks to settle.

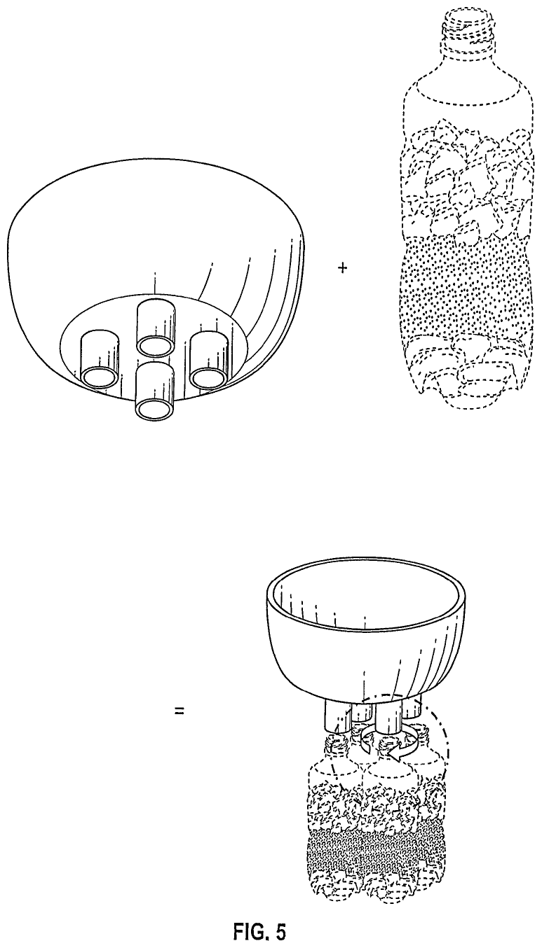

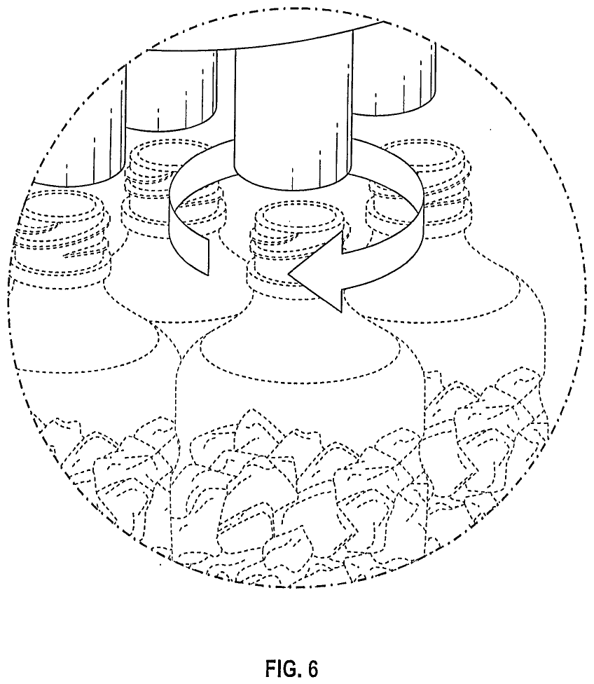

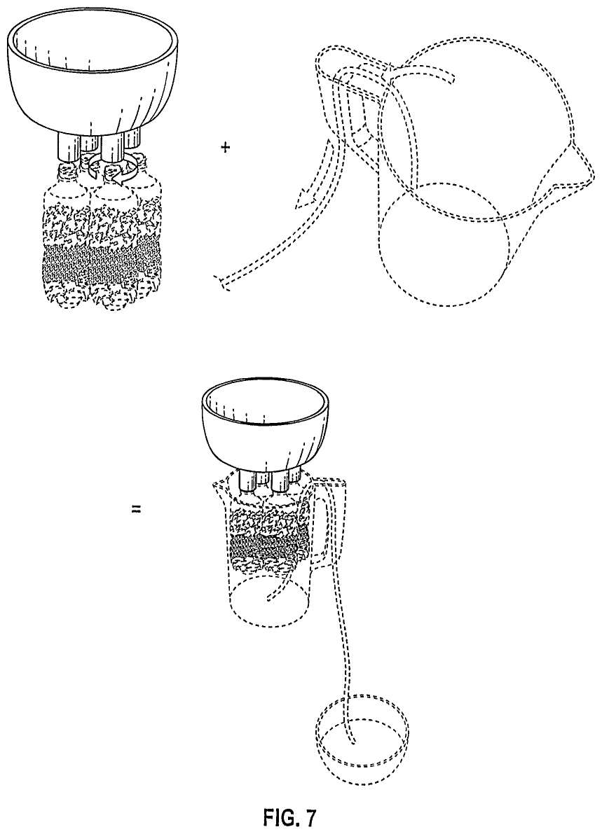

Each of the four water bottles was screwed into each of the shafts of the basin or sink as shown in the figures (e.g., FIGS. 5-7). The combined basin and receptacles containing the filtering layers was placed in a vessel (a 1-gallon plastic pitcher) to collect the filtered liquid. A 120-150 cm piece of tubing 3.175 mm in diameter was threaded through the handle of the plastic pitcher, with one end at the bottom of pitcher, and the other end placed in a collection container.

The gray water was introduced into the basin and the filtered water began to emerge from the bottom of the pierced filtration water bottles. Once sufficient filtered water entered the vessel, the syphon was activated and the liquid moved from the vessel into the collection container. 4 L of water was filtered in 25 minutes.

### Example 2

The filtration method of Example 1 was carried out on water that had first been treated with calcium hypochlorite. One package of Proctor and Gamble Water Purifier was added to 10 L of water, the mixture stirred for 5 minutes and allowed to sit for 5 additional minutes. Bacteria in the water reacted with the calcium hypochlorite to produce yellowish orange beads that were removed prior to introduction of the treated water into the basin.

### Example 3

### Assessing the Filtration Process

### 1. Pre-Filtration Measurements

Before initiating the filtration process, the following parameters are measured and recorded from the input water sample (the pre-filtered water collected from a stream) are measured:

### Physical Properties

### 1. Turbidity:

Measurement Method: Use a turbidity meter.
Procedure: Calibrate the turbidity meter as per the manufacturer's guidelines. Submerge the sensor into the water sample.
Acceptable Range: <5 NTU.
Record: Document the turbidity reading.

### 2. Color:

Measurement Method: Visual inspection.
Procedure: Hold a sample of water against a white background under good lighting.
Acceptable Range: Clear (no noticeable color).
Record: Note any visible color or lack thereof.

### 3. Water Clarity:

Measurement Method: Visual inspection.
Procedure: Observe and rate clarity on a scale of 0 (Cloudy) to 4 (Clear).
Acceptable Range: 4 (Clear).
Record: Assign a clarity score based on the observed level.

### 4. Odor:

Measurement Method: Sensory evaluation.
Procedure: Smell the water sample and assign an odor score on a scale of 0 (Odorless) to 4 (Strong Odor).
Acceptable Range: 0 (Odorless).
Record: Document the odor score.

### Chemical Properties

### 5. pH Level:

Measurement Method: Test kit.
Procedure: Use the provided pH test strips or electronic meter to measure the pH.
Acceptable Range: 6.5-8.5.
Record: Document the pH reading.

### 6. Total Dissolved Solids (TDS):

Measurement Method: TDS device.
Procedure: Submerge the TDS device probe into the water.
Acceptable Range: <500 mg/L.
Record: Note the TDS measurement.

### 7. Chlorine Levels:

Measurement Method: Chlorine test kit.
Procedure: Add reagent as instructed in the kit and compare results to the provided scale.
Acceptable Range: 0.2-0.5 mg/L.
Record: Document the chlorine concentration.

### 8. Heavy Metals (Lead, Arsenic, Mercury):

Measurement Methods: Use respective test kits for each metal.
Procedure: Follow the instructions provided with each test kit for detecting lead (<0.01 mg/L), arsenic (<0.01 mg/L), and mercury (<0.006 mg/L).
Acceptable Ranges: See above for individual limits.
Record: Note the measurements for each metal.

### 9. Hardness:

Measurement Method: Hardness test kit.
Procedure: Use reagents and follow instructions in the kit.
Acceptable Range: <120 ppm.
Record: Document the hardness level.

### Biological Contamination

10. Coliform Bacteria and Pathogens (e.g., E. coli):
Measurement Methods: Use coliform and pathogen test kits.
Procedure: Add water to the test kit, incubate (if required), and check for results.
Acceptable Range: Absent for both.
Record: Indicate the presence or absence of contaminants.

### 2. Filtration Process

### 1. Volume of Water Input:

Use a measuring container to input exactly 3.8 liters of water into the filtration system.

### 2. Time to Filter:

Use a stopwatch to measure the time (in seconds) required for the filtration process to complete.
Record the filtration time.

### 3. Post-Filtration Measurements

Repeat all the above measurements for the filtered water sample (the stream water that has been through the filtering process using the BKS). Use the same methods, procedures, and scales as described above. Be sure to sanitize and clean any testing equipment being reused (a dirty gauge or probe).

### 4. Comments/Observations

During the testing process, note any unexpected observations, including equipment issues, unusual test results, or anomalies in the water's physical or chemical properties.
Document any changes in color, clarity, odor, or other parameters between pre-and post-filtration.

The compositions and processes of the present disclosure will be better understood in connection with the following examples, which are intended as an illustration only and not limiting of the scope of the disclosure. Various changes and modifications to the disclosed embodiments will be apparent to those skilled in the art and such changes and modifications including, without limitation, those relating to the processes, formulations and/or methods of the disclosure may be made without departing from the spirit of the disclosure and the scope of the appended claims.

While this disclosure has been particularly shown and described with references to embodiments thereof, it will be understood by those skilled in the art that various changes in form and details may be made therein without departing from the scope of the disclosure encompassed by the appended claims.

1. A filtration device comprising a basin for receiving liquid to be filtered, wherein said basin comprises one or more shafts on the bottom surface of the basin, and wherein the one or more shafts are configured to tightly connect to a receptacle for receiving and filtering the liquid.

2. The filtration device of claim 1 comprising multiple shafts.

3. The filtration device of claim 1 comprising four shafts.

4. The filtration device of claim 1 composed of plastic.

5. A filtration system comprising the filtration device of claim 1, into which one or more receptacles are threaded into the shafts.

6. The filtration system of claim 5, wherein the one or more receptacles comprise one or more layers of filter materials.

7. The filtration system of claim 6, wherein the one or more receptacles comprise a layer of fibrous material.

8. The filtration system of claim 7, wherein the one or more receptacles further comprise a granular layer on top of the layer of fibrous material.

9. The filtration system of claim 8, wherein the one or more receptacles further comprise a layer of coarse mineral material on top of the granular layer.

10. The filtration system of claim 7, wherein the fibrous material is cotton.

11. The filtration system of claim 8, wherein the granular material is sand.

12. The filtration system of claim 8, wherein the coarse mineral material is rocks or gravel.

13. The filtration system of claim 6, wherein the one or more receptacles comprise holes at a bottom edge of the receptacle.

14. The filtration system of claim 13, further comprising a vessel into which the basin and threaded receptacles are placed, such that the liquid can flow from the basin, be filtered through the receptacles, and be received as filtered liquid in the vessel.

15. The filtration system of claim 14, further comprising tubing which acts as a syphon to remove filtered liquid from the vessel.

16. The filtration system of claim 15, further comprising a collection container for receiving the filtered liquid via the tubing from the vessel.

17. The filtration system of claim 1, wherein the liquid is water.

18. A method for filtering liquid, comprising introducing the liquid into the filtration system of claim 1 and collecting filtered liquid.

19. A kit for filtering liquids, comprising:
a. the filtration device of claim 1; and
b. instructions for assembling a filtering system.

20. The kit of claim 19, further comprising a chemical purifying agent.
